(19) United States
(12) Patent Application Publication
(10) Pub. No.: US 2023/0404157 A1
(43) Pub. Date: Dec. 21, 2023

(54) Valve for Pod Containing E-Liquid

(71) Applicant: JT International SA, Geneva (CH)

(72) Inventors: Broderick Coburn, Mont-Sur-Rolle (CH); Joao Seco, Geneva (CH)

(73) Assignee: JT International SA, Geneva (CH)

(21) Appl. No.: 18/035,661

(22) PCT Filed: Nov. 8, 2021
(86) PCT No.: PCT/EP2021/080900

§ 371 Date: May 5, 2023

(30) Foreign Application Priority Data
Nov. 13, 2020 (EP) 20207497.7

(51) Int. Cl. A24F 40/485; A24F 40/10; A24F 40/42; F16K 7/02

(52) U.S. Cl. CPC A24F 40/485; A24F 40/10; A24F 40/42; F16K 7/02

(57) ABSTRACT

The present invention relates to a capsule for use with an electronic smoking device The capsule includes: a shell having an outer housing and a receiving portion, wherein the receiving portion is configured to receive a connecting portion of a vaporization engine structure of the electronic smoking device, and a vaporizable material encapsulated within the shell The receiving portion is made at least partially of an elastic material and comprises at least one opening that can be brought into an open state, in which the vaporizable material encapsulated in the shell is allowed to flow through the opening, and a closed state, in which the vaporizable material is not allowed to flow through the opening, and the at least one opening is brought into the open state by elastic elongation of the receiving portion, which can occur in a substantially axial direction of the capsule.

### TECHNICAL FIELD

The present invention relates to capsule for use with an electronic smoking device, in particular an electronic cigarette or vaporizer, having a valve for controlling a liquid flow.

### TECHNICAL BACKGROUND

Aerosol generating devices, such as electronic cigarettes or “e-cigarettes” as they are also known, have gained in popularity over the past ten years as an alternative to traditional smoking articles, like cigarettes, cigars, and cigarillos. Developments in the design and configuration of such aerosol generating devices or vaporizer devices are on-going to improve their performance and their reliability, as well as their ease of production and their production costs.

Conventional aerosol generating devices usually include a heater powered by an electrical power source and a liquid reservoir containing flavoured e-liquid that can be volatized using the heater and transferred to a user of the aerosol generating device in an airflow, which is preferably guided through a mouthpiece of the device.

In order to provide a convenient way for a user to load the flavoured e-liquid into the aerosol generating device and to avoid the need for the user to handle the liquid directly, thereby reducing the likelihood of spillage and waste, conventionally capsules are provided. In this way, the integrity, safety and quality of the e-liquid can also be assured, because it is loaded into the shell or container during manufacture to form a pre-manufactured capsule. Correct dosing of the e-liquid is also assured.

Moreover, in order to avoid leakage of the e-liquid stored or encapsulated in the capsule as well as to maintain e-liquid freshness over shelf-life, an opening used for delivering the e-liquid to a vaporization engine structure of the electronic smoking device is usually sealed by using external packaging, such as blister pack before first use. However, once inserted into the electronic smoking device, the sealing sheet is cut by a pin or needle. Hence, in order to avoid leakage of the e-liquid after a first use, conventional capsules are provided with a check valve, in particular a mechanical check valve. Increasing the number of parts of the capsule and making the manufacturing of the capsule more complicated. Leading to higher manufacturing and production cost of the capsules, also making the produced capsules less environmental sustainable.

### SUMMARY OF THE INVENTION

In view of the above, there is the desire to provide a capsule for use with an electronic smoking device, in particular an electronic cigarette or vaporizer, capable of creating a single part interface (valve) for a capsule or pod containing vaporizable material that can allow flow of vaporizable material from the capsule to the electronic smoking device when the capsule is coupled to the device and can stop the flow of vaporizable material when the pod is decoupled from the vaping device, while making the configuration of the valve less complicated, in particular reducing number of parts and simplify an assembly process during the manufacturing of the capsule.

This aim may be achieved by a capsule as defined in claim 1 and an electronic smoking device as defined in claim 14. Embodiments may be found in the dependent claims, the following description and the accompanying drawings.

The term vaporizable material is used throughout the specification to designate any material that is vaporizable in air to form an aerosol. Vaporisation is generally obtained by a temperature increase up to the boiling point of the vaporization material, such as at a temperature up to 400° C., preferably up to 350° C. The vaporizable material may, for example, comprise or consist of an aerosol-generating liquid, gel, or wax or the like, or any combination of these

According to one embodiment of the present invention, provided there is a capsule for use with an electronic smoking device, the capsule including: a shell having an outer housing and a receiving portion, wherein the receiving portion is configured to receive a connecting portion, which is preferably part of a vaporization engine structure, of the electronic smoking device, and a vaporizable material encapsulated within the shell, wherein the receiving portion is made at least partially of an elastic material and comprises at least one opening that can be brought into an open state, in which the vaporizable material encapsulated in the shell is allowed to flow through the opening, and a closed state, in which the vaporizable material is not allowed to flow through the opening, and the at least one opening is brought into the open state by elastic deformation or elastic elongation/expansion of the receiving portion, in particular in a substantially axial direction of the capsule.

Hence, a capsule or cartridge for an electronic smoking device or aerosol generating device is provided, capable of reducing the parts necessary for producing said capsule, while ensuring that a leakage of the encapsulated or stored vaporizable material, in particular e-liquid, is prevented. Thereby, reducing the complexity of production and cost of manufacturing.

In more detail, since the at least partially elastic receiving portion is designed in such a way that it becomes intentionally deformed or elastically elongated/expanded, in particular at the time the capsule is connected to or inserted into the electronic smoking device, more particularly at the time when the connecting portion of the electronic smoking device is received, thereby bringing the at least one opening into the open state, a mechanical check valve can be made obsolete.

In the context of the present invention, the term “intentionally deformed or elastically elongated/expanded” with regard to the “receiving portion” is to be understood such that the receiving portion, in particular its structure and dimensions, is designed in such a way that the deformation or elastic elongation/expansion happens at a defined/wanted point in time, in particular at the moment the connecting portion of the electronic smoking device is received. Hence, accidental or unintended deformation or elastic elongation/expansion of the receiving portion is not to be understood to fall under the desired “intentional” deformation or elastic elongation/expansion.

Moreover, in the context of the present invention, the term “elastic material” with regard to the “receiving portion” is to be understood such that the receiving portion is made of a material that can deform in certain ranges and return to its original shape when an applied load is removed. Such an elastic material may have a maximum Young's modulus of 0.1 GPa and/or a maximum hardness of 100 Shore A, in particular in a range of 10 Shore A to 90 Shore A, at ambient temperature. Hence, the “receiving portion” is preferably made of an elastomeric or silicon or rubber material, in particular thermoplastic elastomer.

On the other hand, the “outer housing” of the shell is preferably made of a material which is rigid or hard and therefore not deformable at ambient temperature when submitted to a compressive constrain of a few Kilograms per square centimetre. Accordingly, in the context of the present invention the terms “rigid” or “hard” with regard to the “outer housing” are to be understood such that the used material has generally a Young's modulus above 0.1 GPa or a hardness above 100 Shore A at ambient temperature.

According to a further embodiment of the present invention, the receiving portion may be configured to be elastically deformed or elastically elongated/expanded when the connecting portion of the electronic smoking device is received and thereby allowing that the at least one opening is brought into the open state.

Moreover, in some embodiments of the present invention, the receiving portion may be configured to bring the at least one opening into the closed state when the connecting portion of the electronic smoking device is removed/extracted from the receiving portion, preferably by being pre-loaded with a compression force.

In some embodiments of the present invention, the receiving portion may be at least in the vicinity of the at least one opening, in particular slit, in a state of compression when the capsule is disconnected from the electronic smoking device. In other words, in a disconnected state, in which the connecting portion of the vaporization engine structure of the electronic smoking device is not inserted into the receiving portion, at least a small area around the at least one opening is in a compressed state. Meaning, a compression force acting on the receiving portion compresses the vicinity of the at least one opening, thereby, bringing the at least one opening into the closed state. Hence, achieving a seal of the at least one opening.

In some embodiments, the compression force may act between the receiving portion and the outer housing and may be preferably generated at the time of manufacture of the capsule.

Moreover, as regards an “axial direction of the capsule”, said direction defines in the present application in general a longitudinal direction of the capsule. However, as the shape of the capsule may vary, the “axial direction of the capsule” also refers to a direction in which the air flows in general through the capsule, namely from the air inlet of the capsule to the end or mouth end of the capsule, which is configured to come into contact with a mouthpiece or in case of the mouth end with the lips of a user during use of the electronic smoking device.

According to a further embodiment of the present invention, the outer housing and the receiving portion may define or form within the shell at least one cavity or reservoir in which the vaporizable material, in particular e-liquid, is contained.

Furthermore, the receiving portion may be part of a valve that is brought into an open state, when the capsule is inserted in or coupled to the electronic smoking device, and is brought into or returns to a closed state, when the capsule is removed from or decoupled from the electronic smoking device.

Moreover, the connecting portion may be a part of a vaporization engine structure of the electronic smoking device, and the at least one opening may allow in the open state the vaporizable material to flow preferably from the capsule, in particular from at least one cavity or reservoir formed within the shell, to or into the connecting portion, in particular to or into the vaporization engine structure of the electronic smoking device.

In some embodiments, the receiving portion may have at least partially a tapered shape, in particular a conical shape or a shape of a nozzle or a shape of a trumpet, which tapers toward the inside of the capsule. In other words, extends away from the side which is configured to be connected to the electronic smoking device.

Furthermore, the receiving portion may be provided with a contact surface, which is preferably formed by a protrusion, a nose or a boss, that is configured to come into contact with the connecting portion when the capsule is inserted in or coupled to the electronic smoking device, thereby elastically deforming or elastic elongating the receiving portion so that the at least one opening is brought into the open state.

Moreover, in some embodiments, the contact surface may be positioned on the receiving portion in such a way that:
a) the contact surface comes into contact with the connection portion before the capsule is fully inserted in or fully coupled to the electronic smoking device, and/or
b) the contact surface comes into contact with the connection portion and moves with the connection portion in an insertion direction of the connection portion into the receiving portion for up to 5 mm, preferably 1 to 3 mm, more preferably 1.5 to 2.5 mm.

According to a further embodiment of the present invention, the at least one opening may be arranged in a straight portion, in particular a cylindrical portion, of the receiving portion, which is positioned in an insertion direction of the connection portion into the receiving portion before a contact surface of the receiving portion.

Moreover, the capsule may comprise at least two openings, preferably four openings, which may be provided on a straight portion of the receiving portion, preferably arranged with a predetermined distance from each other in a circumferential direction of the receiving portion.

Additionally, the outer housing may be formed of a rigid material, in particular a rigid thermoplastic material, glass or metal, and the receiving portion may be formed at least partially, preferably completely, of an elastomeric material such as silicon or a thermoplastic urethane having preferably a hardness in the range of 10 Shore A to 90 Shore A, wherein the outer housing and the receiving portion may be preferably formed integrally.

Moreover, a length of the receiving portion in an insertion direction of the connection portion into the receiving portion may be determined in such a way that when the receiving portion is inserted into the outer housing, preferably at the time of manufacture of the capsule, the receiving portion is compressed, thereby generating a compression force that closes the at least one opening. According to a further embodiment of the present invention, the at least one opening may be formed as a slit, a circle, an oval or the like.

Furthermore, in some embodiments, the outer housing and the receiving portion may be formed integrally by a combination of two-shot or over moulding, welding, bonding or mechanical interference fit. However, it is crucial that the receiving portion (preferably made of elastomeric material), at least in the vicinity of the slits, is in a state of compression when the capsule is disconnected from the electronic smoking device to achieve a seal between the slit contact surface.

As mentioned above, in the context of the present invention the term “state of compression” with regard to the “receiving portion” is to be understood such that when the capsule is in a disconnected or not inserted state in which the connecting portion is not inserted into the receiving portion, a compressing force acts on the receiving portion, in particular the vicinity of the at least one opening, thereby, bringing at least the vicinity of the at least one opening into a compressed state.

Additionally, the capsule may further include a mouthpiece and may be configured to be connected to or coupled to the electronic smoking device.

In some embodiments, the capsule may further include a through hole extending in an insertion direction through the capsule, in particular through the center of the receiving portion, and may be configured to allow vaporized material to flow from the electronic smoking device, in particular a vaporization engine structure, to a mouthpiece or a user. Additionally, the container, shell or outside casing of the capsule may be formed of a rigid material, in particular a rigid thermoplastic material, glass or metal.

According to another embodiment of the present invention, provided there is a an electronic smoking device, in particular a portable hand-held smoking device, including: a case, and a structure for coupling the above described capsule to the electronic smoking device, wherein the structure includes a connecting portion, which is preferably a part of a vaporization engine structure, and the connecting portion is configured to elastically deform or elastically elongate a receiving portion of the capsule when the capsule is coupled to the electronic smoking device.

Furthermore, the case may include an accommodation space configured to receive at least a part of the capsule.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, in which:

FIG. 1 shows a sectional view of a conventional aerosol generating device having a housing consisting of a control body and a tank;

FIG. 2 shows a schematic sectional view of the interior of a capsule for use with an electronic smoking device according to a first embodiment of the present invention;

FIG. 3 shows a schematic sectional view of the capsule shown in FIG. 2 when inserted into an electronic smoking device for use;

FIG. 4 shows a schematic three-dimensional view of the elastic receiving portion of the capsule in a closed and in an open state of the openings;

FIG. 5 shows a schematic sectional view of an electronic smoking device for receiving the capsule shown in FIG. 2;

FIG. 6 shows schematic sectional views of two different types of capsules according to further embodiments of the present invention.

### DETAILED DESCRIPTION

Embodiments of the present disclosure will now be explained with reference to the drawings. It will be apparent to those skilled in the field of aerosol generating devices from this disclosure that the following description of the embodiments is provided for illustration only and not for the purpose of limiting the disclosure as defined by the appended claims. Features of the embodiments described below can also be used to further characterize the device defined in the claims.

Modifications of features can be combined to form further embodiments. Features described in individual embodiments can be provided in a single embodiment if they are not incompatible. Likewise, features described in a single embodiment can be provided in several embodiments individually or in any suitable sub-combination. As used in the specification and the appended claims, the singular forms “a”, “an”, “the” and the like include plural referents unless the context clearly dictates otherwise.

The same reference numerals listed in different figures refer to identical, corresponding or functionally similar elements.

As described hereinafter, example implementations of the present disclosure relate to a capsule for use with an electronic smoking device like for example an aerosol generating devices or aerosol delivery devices. Electronic smoking devices or aerosol generating devices according to the present invention use electrical energy to heat a material (preferably without combusting the material to any significant degree and/or without significant chemical alteration of the material) to form an inhalable substance or vapor; and components of such device have the form of articles that most preferably are sufficiently compact to be considered hand-held devices. That is, use of components of preferred aerosol generating devices does not result in the production of smoke in the sense that aerosol results principally from by-products of combustion or pyrolysis of tobacco, but rather, use of those devices preferably results in the production of vapors resulting from volatilization or vaporization of certain components incorporated therein.

In some example implementations, components of electronic smoking devices or aerosol generating devices may be characterized as electronic cigarettes, and those electronic cigarettes preferably incorporate aerosolisable liquid (e.g. propylene glycol, polyhydric alcohol), tobacco and/or tobacco materials derived at least partially from tobacco, and hence deliver tobacco derived components in aerosol or vapor form to a user. In more detail, electronic smoking devices or aerosol generating devices within the meaning of the present invention may transport the volatilized particles in an airflow through the aerosol generating device, in particular through the capsule or cartomizer, to a user of the device, the user of the device being able to activate or deactivate the generation of aerosol and to control the duration, velocity and volume of the airflow by means of puffing or inhaling action.

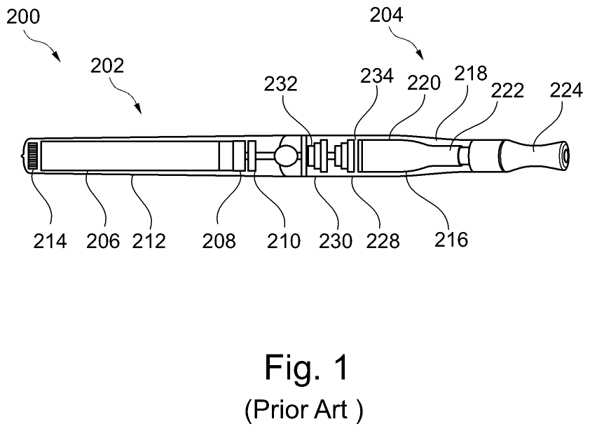

FIG. 1 illustrates a known electronic smoking device or aerosol generating device 200 including a control body 202 and a tank 204. As shown in FIG. 1, the control body 202 can be formed of a control body shell 206 that can include a control component 208 (e.g., a printed circuit board (PCB), an integrated circuit, a memory component, a microprocessor, individually or as part of a micro-controller, and the like), a flow sensor 210, a battery 212, and one or more light-emitting diodes (LEDs) 214, and such components can be variably aligned. Moreover, the tank 204 can be formed of a tank shell 216 enclosing a reservoir 218 that is in fluid communication with a liquid transport element 220 adapted to wick or otherwise transport an aerosol precursor composition stored in the reservoir housing to a heater 222 (sometimes referred to as a heating element). A valve may be positioned between the reservoir and heater and configured to control an amount of aerosol precursor composition passed or delivered from the reservoir to the heater. The known device is provided with a mouthpiece 224 having an opening defined therein and which may be coupled to the tank shell 216 to allow for egress of formed aerosol from the tank 204. The shown device 200, in particular the control body 202 and the tank 204, include a coupler 230 having a cavity 232 therein. A base 228 of the tank is adapted to engage the coupler and includes a projection 234 to fit within the cavity.

Electronic smoking devices or aerosol generating devices of the present invention generally include a number of components provided within an outer body or shell, which may be referred to as an outside casing or housing. The overall design of the outside casing can vary, and the format or configuration of the outside casing that can define the overall size and shape of the aerosol generating device can vary. For some electronic smoking devices or aerosol generating devices, an elongated body resembling the shape of a cigarette or cigar can be formed from a single, unitary housing, or the elongated housing can be formed of two or more separable bodies. For example, an electronic smoking device or an aerosol generating device can include an elongated shell or body (outside casing) that can be substantially tubular in shape and, as such, resemble the shape of conventional cigarettes or cigars. In one implementation, all of the components of the electronic smoking device or aerosol generating device are contained within a single housing. Alternatively, an electronic smoking device or aerosol delivery device can comprise two or more housings that are joined and are separable.

Electronic smoking devices or aerosol generating devices of the present invention can be formed of an outside casing or shell that is not substantially tubular in shape but may be formed to substantially greater transversal dimensions. The outside casing or shell can be configured to include a mouthpiece and/or may be configured to receive a separate shell (e.g. a capsule, a cartridge, a tank) that can include consumable elements, such as a liquid aerosol former, and can include a vaporizer.

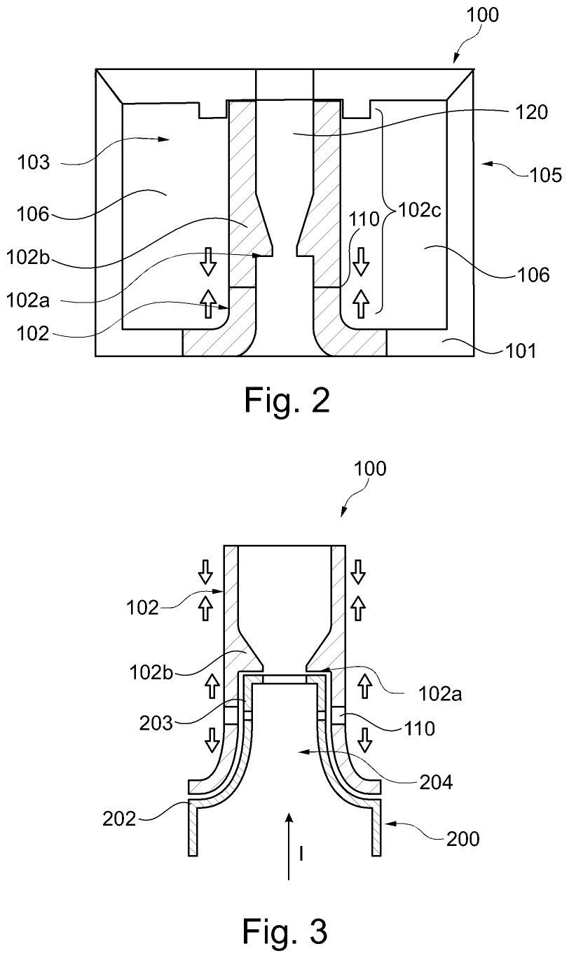

FIG. 2 shows a schematic sectional view of the interior of a capsule 100 for an electronic smoking device 200 or an aerosol generating device according to a first embodiment of the present invention. As can be taken from FIG. 2, the capsule 100 includes a shell 105 having an outer housing 101 and a receiving portion 102. The outer housing 101 and the receiving portion 102 form in the shown embodiment one cavity 103 or reservoir which surrounds the receiving portion 102 and in which the vaporizable material 106 is contained.

The outer housing 101 is formed of a rigid material like a rigid thermoplastic material, glass or metal, and the receiving portion 102 is formed of an elastomeric material such as silicon or a thermoplastic urethane having a hardness in the range of shore 10A to 90A. As shown in FIG. 2, the outer housing 101 and the receiving portion 102 are formed integrally. This can be achieved for example by a combination of two-shot or over moulding, welding, bonding or mechanical interference fitting. However, during this process it is important that the receiving portion 102 is integrated into the outer housing 101 with a certain amount of compression, in particular in the area or vicinity of the opening 110, in order to ensure that the opening 110 is sealed or closed when the capsule 100 is not connected to the electronic smoking device 200.

As can also be taken from FIG. 2, the capsule is also provided with a through hole 120 extending in an insertion direction I, in which the capsule 100 is inserted into the electronic smoking device 200, through the capsule, in particular through the center of the receiving portion 102. The through hole 120 is necessary to allow vaporized material to flow from the electronic smoking device, in particular a vaporization engine structure 204 of the device, to a mouthpiece or a user.

Moreover, as can be taken from FIG. 2, the receiving portion 102 has a tapered shape or tapered area at the entrance (on the end of the receiving portion 102 which faces the outside of the capsule) and changes to a straight portion 102c, which is cylindrically and is provided with two openings 110, which are provided on opposite sides of the straight portion 102c.

FIG. 3 shows a schematic sectional view of the capsule 100 shown in FIG. 2 when inserted into an electronic smoking device 200 for use. As can be taken from FIG. 3, the two openings 110 of the capsule 100 have been brought into an open state by elastic elongation of the receiving portion 102, in particular in an axial direction of the capsule 100 which corresponds to the insertion direction I of the capsule 100 into the electric smoking device 200.

In the open state of the two openings 110, the vaporizable material 106 encapsulated in the shell 105 of the capsule 100 can flow through the openings 110 to the electric smoking device 200, in particular to the vaporization engine structure 204 of the device. Thereby allowing it to vaporize the vaporizable material by a heater and provide the generated vapour through the through hole 120 to a mouthpiece or a user.

As can also be taken from FIG. 3, the inner form of the receiving portion 102 is formed in such a way that it can receive a connecting portion 203 of the electronic smoking device 200, in particular in such a way that the elastically receiving portion 102, in particular the vicinity of the opening 110, is elastically elongated. On the other hand, the part of the receiving portion 102 which is located towards the top of the receiving portion, near the mouthpiece exit, becomes (further) compressed, hence, providing a compression force for the vicinity of the opening 110, which brings the opening 110 into the closed state, when the connecting portion 203 is removed from the receiving portion.

In more detail, when inserting the capsule 100 into the electronic smoking device 200, the connecting portion 203, in particular a projection having a tapered shape, comes into contact with a contact surface 102a formed by a protrusion 102b, in particular a nose, that extends transverse to the insertion direction I into the through hole 120, thereby, reducing an inner diameter of the receiving portion 102. As illustrated in FIG. 3, the contact surface 102a or the protrusion 102b is positioned on or in the receiving portion in such a way that the contact surface 102a comes into contact with the inserted connection portion 203 before the capsule is fully inserted in or fully coupled to the electronic smoking device 200.

In other words, a length from the entrance of the receiving portion 102 to the contact surface 102a is set to be shorter than a length of the projection of the connecting portion 203, at least the length of the projection that is supposed to be inserted into the receiving portion 102. Hence, when inserting the connecting portion 203 into the receiving portion 102, the contact surface 102a or the nose is pushed backward, in other words pushed parallel to the insertion direction I towards a side of the capsule 100 opposite to the entrance of the receiving portion 102. By pushing the contact surface 102a or the nose backward, the straight portion of the receiving is elastically elongated, thereby opening the openings 110. On the other hand, by pushing the contact surface 102a or the nose backward, a portion of the receiving portion 102, which is arranged between the contact surface 102a and the opposite inner side of the capsule 100 becomes compressed, thereby increasing the tension or compressing force applied to the straight portion 102c of the receiving portion. Hence, further urging the openings 110 into the closed state, once the connection portion 203 is removed.

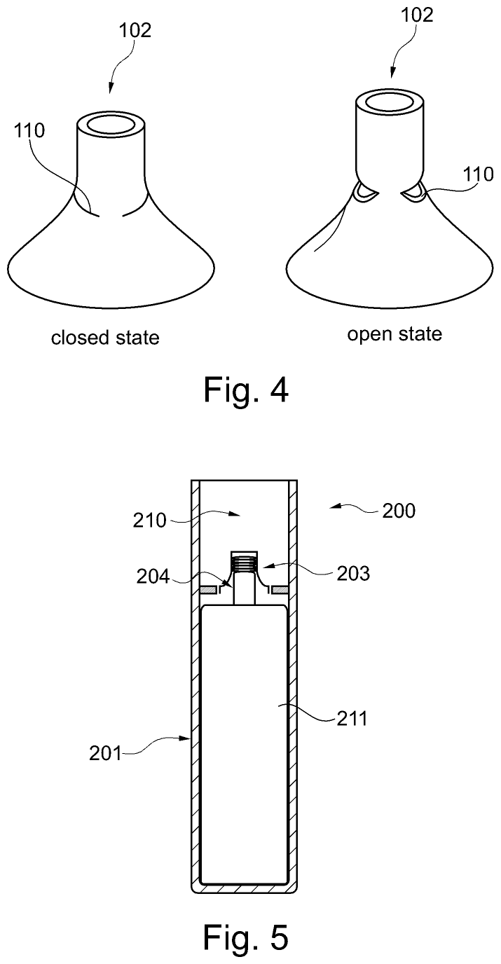

FIG. 4 shows a schematic three-dimensional view of the elastic receiving portion 102 of the capsule 100 in a closed and in an open state of the openings 110. As can be taken from FIG. 4, the provided two openings 110 are formed in the embodiment as slits.

FIG. 5 shows a schematic sectional view of an electronic smoking device 200 for receiving the capsule 100 shown in FIG. 2. The shown electronic smoking device 200 includes a case 201 and a structure 202 for coupling the above described capsule 100 to the electronic smoking device 200. Moreover, the coupling structure 202 of the electronic smoking device 200 includes the connecting portion 203, which is a part of a vaporization engine structure 204 and the connecting portion 203 is configured to elastically deform or elastically elongate the receiving portion 102 of the capsule 100 when the capsule 100 is coupled to the electronic smoking device 200. As FIG. 5 also shows, the electronic smoking device according to the present embodiment is provided with an accommodation space 210 within the case 201 to receive at least a part of the capsule 100.

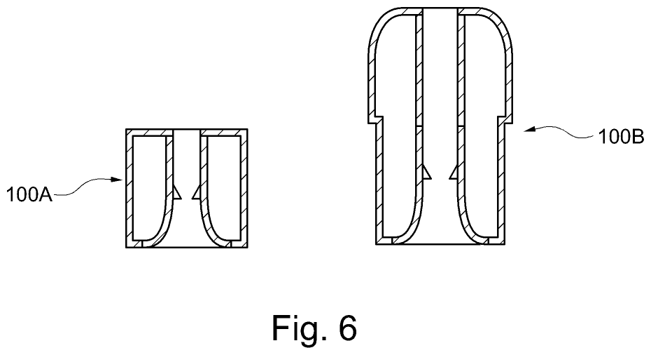

FIG. 6 shows schematic sectional views of two different types of capsules 100 according to further embodiments of the present invention. In the left view of FIG. 6 the capsule 100 has a cylindrical form, where the through hole 120 extends from one flat front surface to another flat front surface. Meaning, this embodiment requests an additional separate mouth piece that is connected to the capsule 100 when in use. The right view of FIG. 6 instead shows a capsule 100 which includes a mouthpiece or is formed on one side, which is opposite to the side that has to be connected to the electronic smoking device 200, in the form of a mouthpiece, thereby making a separate mouth piece obsolete.

### REFERENCE LIST

100 Capsule
101 Outer housing
102 Receiving portion
102a Contact surface
102b Protrusion
102c Straight portion
103 Cavity (Reservoir)
105 Shell
106 Vaporizable material
110 Opening
120 Through hole
200 Electronic smoking device
201 Case
202 (Coupling) Structure
203 Connecting portion
204 Vaporization engine structure

1. A capsule or use with an electronic smoking device, the capsule comprising:
a shell having an outer housing and a receiving portion, wherein the receiving portion is configured to receive a connecting portion of the electronic smoking device, and
a vaporizable material encapsulated within the shell,
wherein the receiving portion is made at least partially of an elastic material and comprises at least one opening that can be brought into an open state, in which the vaporizable material encapsulated in the shell is allowed to flow through the opening, and a closed state, in which the vaporizable material is not allowed to flow through the opening, and
the at least one opening is brought into the open state by elastic elongation of the receiving portion.

2. The capsule according to claim 1, wherein the receiving portion is configured to be elastically elongated when the connecting portion of the electronic smoking device is received and the at least one opening is brought into the open state.

3. The capsule according to claim 1, wherein a compression force acts between the receiving portion and the outer housing.

4. The capsule according to claim 1, wherein when the at least one opening is in the open state, the at least one opening allows the vaporizable material to flow from at least one cavity formed within the shell, to or into the connecting portion and into a vaporization engine structure of the electronic smoking device.

5. The capsule according to claim 1, wherein the receiving portion is provided with a contact surface formed by a protrusion, a nose or a boss, that is configured to come into contact with the connecting portion when the capsule is inserted in or coupled to the electronic smoking device, thereby elastically deforming or elastic elongating the receiving portion so that the at least one opening is brought into the open state.

6. The capsule according to claim 5, wherein the contact surface is positioned on the receiving portion in such a way that:
a) the contact surface comes into contact with the connection portion before the capsule is fully inserted in or fully coupled to the electronic smoking device, and/or
b) the contact surface comes into contact with the connection portion and moves with the connection portion in an insertion direction of the connection portion into the receiving portion for up to 5 mm.

7. The capsule according to claim 1, wherein the at least one opening is arranged in a straight portion of the receiving portion, which is positioned in an insertion direction and before a contact surface of the receiving portion.

8. The capsule according to claim 1, wherein the capsule comprises at least two openings, which are provided on a straight portion of the receiving portion, and the at least two opening are arranged with a predetermined distance from each other in a circumferential direction of the receiving portion.

9. The capsule according to claim 1, where the outer housing is formed of a rigid material, and the receiving portion is formed at least partially of an elastomeric material.

10. The capsule according to claim 1, wherein a length of the receiving portion in an insertion direction, when the receiving portion is inserted into the outer housing, causes the receiving portion to compress, thereby generating a compression force that closes the at least one opening.

11. The capsule according to claim 1, wherein
the at least one opening is formed as a slit, a circle, an oval and/or,
the capsule further comprises a mouthpiece and is configured to be connected to or coupled to the electronic smoking device.

12. The capsule according to claim 1, wherein the outer housing and the receiving portion are formed integrally by a combination of two-shot or over moulding, welding, bonding or mechanical interference fit.

13. The capsule according to claim 1, wherein the capsule further comprises a through hole extending in a insertion direction through the capsule configured to allow vaporized material to flow from the electronic smoking device to a mouthpiece.

14. An electronic smoking device, comprising:
a case, and
a structure for coupling the capsule according to claim 1 to the electronic smoking device,
wherein the structure comprises a connecting portion, and
the connecting portion is configured to elastically elongate the receiving portion of the capsule when the capsule is coupled to the electronic smoking device.

15. The electronic smoking device according to claim 14, wherein the case comprises an accommodation space configured to receive at least a part of the capsule.

16. The capsule of claim 1, wherein the elastic elongation of the receiving portion occurs in a substantially axial direction of the capsule.

17. The capsule of claim 7, wherein the straight portion is a cylindrical portion.

18. The capsule of claim 9, wherein has a hardness in a range of Shore between 10A to 90A.

19. The capsule of claim 18, wherein the outer housing and the receiving portion are formed integrally.

20. The electronic smoking device of claim 14, wherein the structure is part of a vaporization engine structure of the electronic smoking device.
